(19) United States
(12) Patent Application Publication
(10) Pub. No.: US 2020/0224069 A1
(43) Pub. Date: Jul. 16, 2020

(54) ORGANOPOLYSILOXANE COMPOSITION FOR FORMING PRESSURE SENSITIVE ADHESIVE LAYER AND USE OF SAME

(71) Applicant: DOW TORAY CO., LTD., Shinagawa-ku, Tokyo (JP)

(72) Inventors: Maki ITOH, Ichihara-Shi, Chiba (JP); Akihiro NAKAMURA, Ichihara-Shi, Chiba (JP); Michitaka SUTO, Ichihara-Shi, Chiba (JP)

(21) Appl. No.: 16/628,961

(22) PCT Filed: Jun. 28, 2018
(86) PCT No.: PCT/JP2018/024553

§ 371 Date: Mar. 20, 2020

(30) Foreign Application Priority Data
Jul. 7, 2017 (JP) 2017-133255

(51) Int. Cl. C09J 183/04; C08L 83/04; C09J 7/38; C08G 77/00; G06F 3/041

(52) U.S. Cl. CPC C09J 183/04; C08L 83/04; C09J 7/38; C08G 77/70; G06F 3/041; C08G 2170/40; C08L 2205/025; C08L 2205/03; C08L 2201/10; C08L 2203/20; C09J 2483/00

(57) ABSTRACT

A curable organopolysiloxane composition with excellent handling workability and curability by a hydrosilylation reaction, which forms a pressure sensitive adhesive layer that firmly adheres to a base material of a display device or the like, is disclosed. An application thereof is also disclosed. The organopolysiloxane composition with pressure sensitive adhesive layer forming properties is a hydrosilylation reactive organopolysiloxane composition where a molar ratio (e.g. SiH/Vi ratio) of an SiH group in an organopolysiloxane (C) with regard to a sum of an amount of alkenyl groups in an organopolysiloxane (A) having an alkenyl group and an organopolysiloxane resin (B) is at an amount of 20 to 60.

### TECHNICAL FIELD

The present invention relates to a curable organopolysiloxane composition for forming a pressure sensitive adhesive layer; more particularly it relates to a curable organopolysiloxane composition with excellent curability for forming a pressure sensitive adhesive layer that firmly adheres to a base material of a display device or the like, and more particularly relates to an organopolysiloxane composition with pressure sensitive adhesive layer forming properties used in an optical member, which can be designed so as to provide transparency and an appropriate adhesive force. Furthermore, the present invention relates to a pressure sensitive adhesive composition using the composition, a laminate using the composition, an application such as an electronic component or display device (including a touch panel), and the like.

### BACKGROUND TECHNOLOGY

Polysiloxane pressure sensitive adhesive compositions have superior electrical insulation, heat resistance, cold resistance, and adhesion to various adherends as compared to acrylic or rubber pressure sensitive adhesive compositions, and therefore are used on heat resistant pressure sensitive adhesive tapes, electrically insulating pressure sensitive adhesive tapes, heat sealing tapes, plating masking tapes, and the like. Polysiloxane pressure sensitive adhesive compositions are classified into addition reaction curing types, condensation reaction curing types, peroxide curing types, and the like based on the curing mechanism. The addition reaction curing type pressure sensitive adhesive compositions are generally used because the composition is quickly cured by leaving to stand at room temperature or heating and a byproduct is not generated.

Taking advantage of high transparency and the aforementioned properties of the polysiloxane pressure sensitive adhesives, application to a field of advanced electronics displaying elements such as smart devices and the like have been studied in recent years. The devices have a structure where a film containing a plurality of layers including an electrode layer and displaying layer is sandwiched between transparent base materials. The polysiloxane pressure sensitive adhesives with high heat resistance, cold resistance, and transparency are expected to effectively work for the purpose of protecting the electrode layer and displaying layer and improving adhesion between layers. For example, Japanese PCT Application 2014-522436 (Patent Document 1), Japanese PCT Application 2013-512326 (Patent Document 2), and the like disclose manufacturing of an optically transparent silicone pressure sensitive adhesive film and a display device such as a touch panel or the like using the film.

In these fields, and particularly in the field of silicone pressure sensitive adhesive films for optical applications, improvement of curability of silicone pressure sensitive adhesive films is strongly required from the perspective of improving a yield rate of an obtained display device, improving productivity, improving quality, and the like. Furthermore, in response to changes in a physical structure and diversification in display devices represented by flexible displays such as foldable displays and the like, and curved displays for applications in vehicles, a silicone pressure sensitive adhesive film that can respond to various stress changes applied on a display device and that has a strong interlayer adhesive force is required, and improvement of adhesion of an adhesive layer to a base material is more strongly required than conventional. However, existing silicone pressure sensitive adhesive compositions and silicone pressure sensitive adhesive films obtained by curing the composition still have room for improvement in these properties.

On the other hand, with the addition curable polysiloxane pressure sensitive adhesive composition, a molar ratio (hereinafter, also referred to as “SiH/Vi ratio”) of alkenyl groups and silicon-bonded hydrogen atom (SiH) groups included in the organopolysiloxane containing an alkenyl group as a main agent and organohydrogen polysiloxane as a crosslinking agent in the presence of a hydrosilylation reaction catalyst, tends to be widely proposed in the Patent Documents (for example, Patent Documents 3 to 8).

For example, in Patent Document 3 and Patent Document 8, a pressure sensitive adhesive composition with an SiH/Vi ratio that is within a range of 0.5 to 20 is proposed. There is instruction that when the ratio exceeds 20, crosslinking density increases, and a sufficient adhesive force (tack) cannot be achieved. It is suggested that when a pressure sensitive sheet is prepared, a usable time of the pressure sensitive adhesive composition during coating is reduced (for example, paragraph 0024 of Patent Document 3, paragraph 0028 of Patent Document 8, and the like).

Furthermore, Patent Document 5 (paragraph 0029, claim 29, and the like) discloses a silicone pressure sensitive adhesive with an SiH/Vi ratio of 1 to 30. However, a composition disclosed in an optimal range and example is limited to a composition having an SiH/Vi ratio of 1 to 10. Similarly, Patent Document 7 (paragraph 0025, claim 6, and the like) discloses a silicone pressure sensitive adhesive composition with excellent transparency and having an SiH/Vi ratio of 1 to 40. However, compositions in an optimal range and disclosed in the examples are limited to a composition having an SiH/Vi ratio of 1 to 10.

Furthermore, the present applicant proposes a silicone pressure sensitive adhesive with an SiH/Vi ratio within a range of 1 to 20 in Patent Document 4 (upper right column on page 3 of the document), and proposes a silicone pressure sensitive adhesive with an SiH/Vi ratio within a range of 2 to 50 in Patent Document 6 (paragraph 0032, claim 1, and the like). However, a composition disclosed in an optimal range and example in Patent Document 5 is limited to a composition with an SiH/Vi ratio within a range of 1 to 20.

As described above, not only is a silicone pressure sensitive adhesive with an SiH/Vi ratio exceeding 20 not specifically disclosed in any of the Patent Documents, but when a person with ordinary skill in the art performs actual composition design, there is a description that provides incentive to design an addition curable silicon pressure sensitive adhesive composition with an SiH/Vi ratio that is less than 20 or less than 10. Therefore, the Patent Documents are not intended to describe or teach a person with ordinary skill in the art to select an SiH/Vi ratio exceeding 20 and instead prevents a person with ordinary skill in the art from selecting the SiH/Vi ratio.

### PRIOR TECHNOLOGY DOCUMENTS

### Patent Documents

### Patent Document 1: Japanese PCT Application 2014-522436

### Patent Document 2: Japanese PCT Application 2013-512326

### Patent Document 3: JP 2004-168808 A

### Patent Document 4: JP S63-022886 A

### Patent Document 5: JP H05-214316 A

### Patent Document 6: JP 2011-012092 A

### Patent Document 7: Japanese PCT Application 2014-522436

### Patent Document 8: JP 2007-326312 A

### SUMMARY OF THE INVENTION

### Problem to be Solved by the Invention

In order to resolve the aforementioned problems, an object of the present invention is to provide a curable organopolysiloxane composition with excellent curability, which forms a pressure sensitive adhesive layer that firmly adheres to a base material of a display device or the like. Furthermore, an object of the present invention is to provide a use for the curable organopolysiloxane composition and cured product thereof as a pressure sensitive adhesive layer, a use as an electronic material or display device member, and an electronic component or display device provided therewith.

### Means for Solving Problems

As a result of extensive studies of the aforementioned problems, the present inventors achieved the present invention. In other words, one object of the present invention was achieved by an organopolysiloxane composition with pressure sensitive adhesive layer forming properties, containing: (A) an organopolysiloxane having an average of more than one alkenyl group in a molecule; (B) an organopolysiloxane resin; (C) an organohydrogen polysiloxane having at least two Si—H bonds in a molecule; and (D) a hydrosilylation reaction catalyst; where an amount of component (C) is an amount where a ratio (molar ratio) of an amount (substance amount) of an SiH group in component (C) with regard to a sum of an amount (substance amount) of alkenyl groups in component (A) and amount (substance amount) of alkenyl groups in component (B) is 20 to 60. Furthermore, the aforementioned problem can be achieved by a curable organopolysiloxane composition, use of a cured product thereof as a pressure sensitive adhesive layer, use of the cured product as an electronic material or display device member, and an electronic component or display device provided therewith.

In other words, the present invention is:

“[1] An organopolysiloxane composition with pressure sensitive adhesive layer forming properties, containing:
(A) an organopolysiloxane having an average of more than one alkenyl group in a molecule;
(B) an organopolysiloxane resin;
(C) an organohydrogen polysiloxane having at least two Si—H bonds in a molecule; and
(D) a hydrosilylation reaction catalyst; where
an amount of component (C) is an amount where a ratio (molar ratio) of an amount (substance amount) of an SiH group in component (C) with regard to a sum of an amount (substance amount) of alkenyl groups in component (A) and amount (substance amount) of alkenyl groups in component (B) is 20 to 60;
[2] The curable organopolysiloxane composition with pressure sensitive adhesive layer forming properties according to [1], where the amount of component (C) is an amount where a ratio (molar ratio) of a substance amount of an SiH group in component (C) with regard to a sum of substance amounts of alkenyl groups in component (A) and component (B) is 22 to 50;
[3] The organopolysiloxane composition with pressure sensitive adhesive layer forming properties according to [1] or [2], where
at least a portion of component (A) is (A1) a raw rubber-like organopolysiloxane containing an alkenyl group, having a viscosity of 100,000 mPa·s or more at 25° C., or a degree of plasticity as measured in accordance with a method stipulated in JIS K6249 within a range of 50 to 200, at least a portion of component (B) is (B1) a resin that contains an R3SiO1/2 unit (M unit) and an SiO4/2 unit (Q unit), and may have a hydroxyl group or hydrolyzable group (where R represents a monovalent organic group and 90 mol % or more or R is a phenyl group or alkyl group with 1 to 6 carbon atoms), and
an amount of a vinyl (CH2=CH) moiety in an alkenyl group in component (A1) is within a range of 0.005 to 0.400 wt. %, and component (B) is within a range of 1 to 500 parts by mass with regard to 100 parts by mass of a sum of component (A) and component (C) in the composition;
[4] The organopolysiloxane composition with pressure sensitive adhesive layer forming properties according to [3], where the component (A) is a mixture of the component (A1) and (A2) an organopolysiloxane containing an alkenyl group with a viscosity at 25° C. that is less than 100,000 mPa·s, and a mass ratio of both that is within a range of 50:50 to 100:0;
[5] The organopolysiloxane composition with pressure sensitive adhesive layer forming properties according to any one of [1] to [4], further containing at least one type of (E) curing retarder;
[6] The organopolysiloxane composition with pressure sensitive adhesive layer forming properties according to any one of [1] to [5], where a viscosity of the composition after 8 hours at room temperature from preparing the composition is within 1.5 times a viscosity of the composition immediately after preparing the composition, and curing is possible at 80 to 200° C.;
[7] The organopolysiloxane composition with pressure sensitive adhesive layer forming properties according to any one of [1] to [6], where an amount of a platinum-based metal in solid content is within a range of 0.1 to 200 ppm;
[7-1] From the perspective of low coloring properties, an amount of the platinum-based metal is preferably within a range of 0.1 to 100 ppm, and may be within a range of 0.1 to 50 ppm;
[8] The organopolysiloxane composition with pressure sensitive adhesive layer forming properties according to any one of [1] to [7], where a cured layer having a thickness of 100 μm obtained by curing the composition is essentially transparent, and
a polymethyl methacrylate sheet with a thickness of 2 mm provided with a 50 μm thick cured layer obtained by curing the composition has an adhesive force as measured at a tensile rate of 300 mm/min using a 180° peeling test method in accordance with JIS Z 0237 of 0.02 N/25 mm or more;
[9] A pressure sensitive adhesive composition, containing the organopolysiloxane composition with pressure sensitive adhesive layer forming properties according to any one of [1] to [8];
[10] A pressure sensitive adhesive layer obtained by curing the organopolysiloxane composition with pressure sensitive adhesive layer forming properties according to any one of [1] to [8];
[11] The pressure sensitive adhesive layer according to [10], which is film-like and essentially transparent;
[12] A laminate, containing a pressure sensitive adhesive layer obtained by curing the organopolysiloxane composition with pressure sensitive adhesive layer forming properties according to any one of [1] to [8] on a film-like base material;
[13] The laminate according to [12], where a release layer for the pressure sensitive adhesive layer is provided on 1 or more film-like base materials;
[14] The laminate according to [12] or [13], containing:
a film-like base material;
a first release layer formed on the film-like base material;
a pressure sensitive adhesive layer formed by coating and curing the organopolysiloxane composition with pressure sensitive adhesive layer forming properties according to any one of [1] to [8] on the release layer; and
a second release layer laminated on the pressure sensitive adhesive layer;
[15] A member for a display device or an electronic material, obtained by curing the organopolysiloxane composition with pressure sensitive adhesive layer forming properties according to any one of [1] to [8];
[16] An electronic component or display device, containing the member for a display device or the electronic material according to [15];
[17] A display panel or a display, containing the film-like and essentially transparent pressure sensitive adhesive layer according to [11];
[18] A touch panel, containing a pressure sensitive adhesive layer obtained by curing the organopolysiloxane composition with pressure sensitive adhesive layer forming properties according to any one of [1] to [8] adhered to a base material where a conductive layer is formed on one surface and to the conductive layer of the base material or on a surface opposite thereof; and
[19] The touch panel according to [18], where the base material where the conductive layer is formed is a resin film or glass sheet where an ITO layer is formed on one surface.

### Effect of the Invention

An organopolysiloxane composition with pressure sensitive adhesive layer forming properties of the present invention has excellent adhesion and curability by a hydrosilylation reaction, can firmly adhere to a base material of a display device or the like, and can form a pressure sensitive adhesive layer that can be designed to have high transparency. Furthermore, the curable organopolysiloxane composition or cured product thereof can be suitably used as a pressure sensitive adhesive layer, and electronic material, or member for a display device. An electronic component for display device provided therewith can form a pressure sensitive adhesive layer that is less likely to cause curing defect problems of a pressure sensitive adhesive film and adhesion defect problems with regard to a base material of a display device or the like. Therefore, advantages are provided where industrialization is simple and performance of a laminate of an obtained display device or the like can be improved. In particular, a display device can be obtained such as a display panel, display, touch panel, or the like provided with a pressure sensitive adhesive layer obtained by curing the organopolysiloxane composition according to the present invention.

### DESCRIPTION OF THE PREFERRED EMBODIMENTS

Organopolysiloxane Composition with Pressure Sensitive Adhesive Layer Forming Properties

First, an organopolysiloxane composition with pressure sensitive adhesive layer forming properties according to the present invention will be described. The composition forms a cured layer with pressure sensitive adhesive properties that firmly adheres to a base material of a display device or the like by a curing reaction including a hydrosilylation reaction, and is less likely to cause a curing defect problem. Hereinafter, components and technical characteristics of an SiH/Vi ratio range and the like will be described.

As described above, the organopolysiloxane composition of the present invention is cured by a hydrosilylation reaction to form a pressure sensitive adhesive layer having a constant adhesive force, and therefore at least contains the following components (A) to (D).

(A) An organopolysiloxane having an average of more than one alkenyl group in a molecule;
(B) An organopolysiloxane resin;
(C) An organohydrogen polysiloxane having at least two Si—H bonds in a molecule; and
(D) A hydrosilylation reaction catalyst
Furthermore, the composition contains a hydrosilylation reaction catalyst, and therefore preferably contains (E) a curing retarder from the perspective of handling workability. The composition may contain another additive within a range that is consistent with an object of the present invention. Hereinafter, the components will be described.

Organopolysiloxane containing an alkenyl group of the component (A) is a main agent (base polymer) of the composition, and contains an alkenyl group bonded to more than one silicon atom on average in one molecule. A preferred number of alkenyl groups is 1.5 or more in one molecule. Examples of an alkenyl group of the organopolysiloxane in the component (A) include vinyl groups, allyl groups, butenyl groups, pentenyl groups, hexenyl groups, heptenyl groups, and other alkenyl groups with 2 to 10 carbon atoms. Vinyl groups and hexenyl groups are particularly preferable. Examples of a bonding position of the alkenyl group in the component (A) include ends of a molecular chain and/or side chains of a molecular chain. Note that the component (A) may contain only a single component, or may be a mixture of two or more different components.

Examples of organic groups bonded to a silicon atom other than the alkenyl group in the organopolysiloxane in the component (A) include: methyl groups, ethyl groups, propyl groups, butyl groups, pentyl groups, hexyl groups, heptyl groups, and other alkyl groups; phenyl groups, tolyl groups, xylyl groups, naphthyl groups, and other aryl groups; benzyl groups, phenethyl groups, and other aralkyl groups; chloromethyl groups, 3-chloropropyl groups, 3,3,3-trifluoropropyl groups, and other halogenated alkyl groups; and the like. Methyl groups or phenyl groups are particularly preferable.

A molecular structure of component (A) is preferably a straight chain or a straight chain having a partial branch (branched chain) for example, and may partially contain a cyclic shape or three-dimensional network. A straight chain or branched chain diorganopolysiloxane is preferable, where a main chain is formed from repeating diorganosiloxane units, and where both ends of a molecular chain are blocked by a triorganosiloxy group. Note that a siloxane unit that provides a branched chain organopolysiloxane is a T unit or Q unit described later.

The properties of component (A) at room temperature may be oil-like or rubber-like, and the viscosity of component (A) is preferably 50 mPa·s or more at a temperature of 25° C., and particularly preferably 100 mPa·s or more. In particular, if the curable silicone composition is a solvent, at least a portion of the component (A) is preferably (A1) a raw rubber-like organopolysiloxane containing an alkenyl group having a viscosity of 100,000 mPa·s or more at 25° C. or having a degree of plasticity (value when a load of 1 kgf is applied for 3 minutes on 4.2 g of spherical sample at 25° C.) as measured in accordance with a method specified in JIS K6249 that is within a range of 50 to 200, and more preferably within a range of 80 to 180.

Note that in the organopolysiloxanes containing an alkenyl group, volatile or low molecular weight siloxane oligomers (such as octamethyl tetrasiloxane (D4), decamethyl pentasiloxane (D5), and the like) are preferably reduced or removed for the purpose of preventing a contact fault or the like. Although the extent thereof can be designed as desired, the entire component (A) may be set to less than 1 mass %, and the siloxane oligomers may be set to less than 0.1 mass %. The amount may be reduced to near a detection limit if necessary.

An amount of the alkenyl group in the component (A1) is not particularly limited, but from the perspective of technical effects of the present invention, an amount of a vinyl (CH₂═CH) moiety in the alkenyl group in the component (A1) (hereinafter, referred to as “vinyl amount”) is preferably within a range of 0.005 to 0.400 wt. %, and particularly preferably within a range of 0.005 to 0.300 wt. %.

The component (A) with a lower viscosity than the component (A1) can also be used as the component (A) of the present invention. Specifically, (A2) an organopolysiloxane containing an alkenyl group with a viscosity that is less than 100,000 mPa·s at 25° C. can be used. Herein, examples other than the viscosity of component (A2) are similar to component (A1). In particular, when component (A2) with a low viscosity is used in combination with component (A1), handling workability may be improvable when adding the hydrosilylation reaction catalyst, which is component (C), described later.

From the perspective of technical effects of the present invention, 50% by mass or more of the component (A) is preferably an organopolysiloxane containing and alkenyl group with a high degree of polymerization serving as the component (A1), and 75 to 100% by mass is particularly preferably the component (A1). In other words, when the component (A1) (=organopolysiloxane containing an alkenyl group with a high degree of polymerization) and component (A2) (=organopolysiloxane containing an alkenyl group with a lower degree of polymerization) are both used as the component (A), a mass ratio of both is within a range of 50:50 to 100:0, and more preferably within a range of 75:25 to 100:0 or 75:25 to 90:10.

The organopolysiloxane resin (B) is an adhesion providing component that provides an adhesive force on a base material, and is not particularly limited so long as the organopolysiloxane has a three-dimensional structure. Examples can include: resins containing an R₂SiO_{2/2} unit (D unit) and RSiO_{3/2} unit (T unit) (where R represents a mutually independent monovalent organic group) and that has or does not have a hydroxyl group or hydrolyzable group; resins independently containing a T unit and that has does or does not have a hydroxyl group or hydrolyzable group; resins containing an R₃SiO_{1/2} unit (M unit) and SiO_{4/2} unit (Q unit) and that has or does not have a hydroxyl group or hydrolyzable group; and the like. In particular, (B1) a resin containing an R₃SiO_{1/2} unit (M unit) and SiO_{4/2} unit (Q unit) and that has a hydroxyl group or hydrolyzable group (also referred to as an MQ resin) is preferably used. Note that the hydroxyl group or hydrolyzable group is a group is directly bonded to silicon such as a T unit, Q unit, or the like in the resin, and is a group derived from a silane serving as a raw material or produced as a result of hydrolyzing a silane.

The monovalent organic group of R is preferably a monovalent hydrocarbon group with 1 to 10 carbon atoms, and examples include alkyl groups with 1 to 10 carbon atoms, alkenyl groups with 2 to 10 carbon atoms, aryl groups with 6 to 10 carbon atoms, cycloalkyl groups with 6 to 10 carbon atoms, benzyl groups, phenylethyl groups, and phenylpropyl groups. In particular, 90 mol % or more of R is preferably an alkyl group with 1 to 6 carbon atoms or a phenyl group, and 95 to 100 mol % of R is particularly preferably a methyl group or phenyl group.

When the organopolysiloxane resin (B) is a resin containing an R₃SiO_{1/2} unit (M unit) and SiO_{4/2} unit (Q unit), a molar ratio of M units to Q units is preferably 0.5 to 2.0. This is because when the molar ratio is less than 0.5, an adhesive force to a base material is reduced, and when the molar ratio is more than 2.0, a cohesive force of a substance configuring a pressure sensitive adhesive layer is reduced. Furthermore, a D unit and Q and T units can be included in the component (B), and the component (B) can be used in combination with two or more types of organopolysiloxanes, within a scope that does not impair the properties of the present invention. The organopolysiloxane resin (B) may have a hydroxyl group or hydrolyzable group, and a resin having a hydroxyl group or hydrolyzable group, a resin not having a hydroxyl group or hydrolyzable group, or a mixture thereof can be used without limitation. When the organopolysiloxane resin has a hydroxyl group or hydrolyzable group, 0.1 to 5.0% by mass of the hydroxyl group or hydrolyzable group is normally included. Note that in the organopolysiloxane resins, a low molecular weight siloxane oligomer may be reduced or removed for the purpose of preventing a contact fault or the like.

The component (C) is an organohydrogen polysiloxane having two or more Si—H bonds in a molecule, and is a crosslinking agent of the organopolysiloxane composition according to the present invention. A molecular structure of component (C) is not limited, and examples include straight chains, straight chains partially having a branch, branched chains, cyclic forms, and organopolysiloxane resins. The molecular structure is preferably a straight chain, straight chain partially having a branch, or an organopolysiloxane resin. A bonding position of a silicon-bonded hydrogen atom is not particularly limited, and examples include molecular chain ends, side chains, and both.

An amount of the silicon-bonded hydrogen atom is preferably 0.1 to 2.0 wt. %, and more preferably 0.5 to 1.7 wt. %.

Examples of the organic group bonded to a silicon atom include: methyl groups, ethyl groups, propyl groups, butyl groups, octyl groups, and other alkyl groups with 1 to 8 carbon atoms; phenyl groups, tolyl groups, and other aryl groups; benzyl groups, phenethyl groups, and other aralkyl groups; and 3-chloropropyl groups, 3,3,3-trifluoropropyl groups, and other halogenated alkyl groups. However, 50 mol % or more of the total number thereof is preferably an alkyl group with 1 to 8 carbon atoms or a phenyl group. Another organic group is preferably a methyl group or phenyl group from the perspective of ease of manufacturing and compatibility the aforementioned preferred component (A) and component (B).

When component (C) according to the present invention is an organohydrogen polysiloxane as an organopolysiloxane resin, examples include: organopolysiloxane copolymers containing a siloxane unit as expressed by general formula: R′₃SiO_{1/2}, siloxane unit as expressed by general formula: R′₂HSiO_{1/2}, and siloxane unit as expressed by formula: SiO_{4/2}; organopolysiloxane copolymers containing a siloxane unit as expressed by general formula: R′₂HSiO_{1/2} and siloxane unit as expressed by general formula: SiO_{4/2}; organopolysiloxane copolymers containing a siloxane unit as expressed by general formula R′₂HSiO_{1/2} and siloxane unit as expressed by general formula: R″SiO_{3/2}; organopolysiloxane copolymers containing a siloxane unit as expressed by general formula: R′HSiO_{2/2}, and siloxane unit as expressed by general formula: R′SiO_{3/2}, or siloxane unit as expressed by formula: HSiO_{3/2}; and mixtures of two or more types of the organopolysiloxanes. Note that R′ in the formula represents an alkyl group with 1 to 8 carbon atoms, an aryl group, an aralkyl group, or halogenated alkyl group, and the same groups as described above are exemplified.

Specific examples of the component (C) include tris (dimethyl hydrogen siloxy) methylsilane, tetra (dimethyl hydrogen siloxy) silane, methylhydrogen polysiloxane blocked with a trimethylsiloxy group at both ends, dimethylsiloxane blocked with a trimethylsiloxy group at both ends/methylhydrogen siloxane copolymers, dimethylsiloxane blocked with a dimethyl hydrogen siloxy group at both ends/methylhydrogen siloxane copolymers, cyclic methylhydrogen oligosiloxane, cyclic methylhydrogen siloxane/dimethylsiloxane copolymers, methylhydrogen siloxane blocked with a trimethylsiloxy group at both ends of a molecular chain/diphenylsiloxane copolymers, methylhydrogen siloxane blocked with a trimethylsiloxy group at both ends of a molecular chain/diphenylsiloxane/dimethylsiloxane copolymers, hydrolytic condensates of trimethoxysilane, copolymers containing a (CH₃)₂HSiO_{1/2} unit and SiO_{4/2} unit, copolymers containing a (CH₃)₂HSiO_{1/2} unit, SiO_{4/2} unit, and (C₆H₅)SiO_{3/2} unit, copolymers containing a (CH₃)₂HSiO_{1/2} unit and CH₃SiO_{3/2} unit, and mixtures of two or more thereof.

For a straight chain, a methylhydrogen polysiloxane is particularly preferable, which is expressed by molecular structural formula:

R^{T}Me₂SiO(Me₂SiO)_{q}(HMeSiO)ᵣSiMe₂R^{T} (7)

(Where Me represents a methyl group; RT represents a methyl group or hydrogen atom, q and r are numbers satisfying a relationship of 0.3≤r/(q+r)≤1 and 10≤(q+r)≤200). Note that component (C) may be used in combination with two or more different components.

Similarly, the following organosiloxanes are exemplified. Note that in the formula, Me and Ph respectively represents a methyl group and phenyl group, m represents an integer between 1 and 100, n represents an integer between 1 and 50, and b, c, d, and e represent a positive number. However, the total of b, c, d, and e in one molecule is 1.

HME₂SiO(Ph₂SiO)ₘSiMe₂H

HMePhSiO(Ph₂SiO)ₘSiMePhH

HMePhSiO(Ph₂SiO)ₘ(MePhSiO)ₙSiMePhH

HMePhSiO(Ph₂SiO)ₘ(Me₂SiO)ₙSiMePhH

(HMe₂SiO_{1/2})_{b}(PhSiO_{3/2})_{c}

(HMepHSiO_{1/2})_{b}(PhSiO_{3/2})_{c}

(HMePhSiO_{1/2})_{b}(HMe₂SiO_{1/2})_{c}(PhSiO_{3/2})_{d}

(HMe₂SiO_{1/2})_{b}(Ph₂SiO_{2/2})_{c}(PhSiO_{3/2})_{d}

(HMePhSiO_{1/2})_{b}(Ph₂SiO_{2/2})_{c}(PhSiO_{3/2})_{d}

(HMePhSiO_{1/2})_{b}(HMe₂SiO_{1/2})_{c}(Ph₂SiO_{2/2})_{d}(PhSiO_{3/2})ₑ

SiH/Vi Ratio

The composition of the present invention is characterized by having a high SiH/Vi ratio that achieves technical effects thereof. In other words, an amount of component (C) used in the composition of the present invention may be a substance amount of a silicon-bonded hydrogen atom (SiH) group in component (C) with regard to the total amount of the alkenyl groups in component (A) (substance amount) and of the alkenyl groups in component (B) (substance amount) in the composition. In other words, the molar ratio may be within a range of 20 to 60, a range of 22 to 50, and a range of 25 to 40.

An amount of the SiH group must be the lower limit, in other words, 20 or more, preferably over 20, and more preferably 22 or more. When the amount of the SiH group is lower than the lower limit, curability of the composition is reduced, which may cause curing defects. Furthermore, a technical effect of improving adhesion to a base material may not be achieved. On the other hand, when the amount of the SiH group exceeds the upper limit, an amount of a curing agent remaining without reacting increases, and thus an adverse effect such as a cured product being brittle and the like and a problem such as gas generating and the like may occur.

An effect of improving curing defects of the composition is considered as follows. The organopolysiloxane composition according to the present invention must form a pressure sensitive cured layer, and therefore, an organopolysiloxane resin and organopolysiloxane containing an alkenyl group having a high degree of polymerization are generally primarily used. The components tend to have a low number of alkenyl groups in a molecule and low density of alkenyl groups in the composition, as compared to a vinyl polysiloxane having a low degree of siloxane polymerization used for silicone sealants and the like. At this time, in the case that the hydrosilylation reaction catalyst (D) described later is added, when an organopolysiloxane containing an alkenyl group with a lower degree of polymerization than component (A1) is used, the density of alkenyl groups in a molecule is relatively high in the siloxanes with a low degree of polymerization. Therefore, a hydrosilylation reaction may locally advance in a vicinity of the organopolysiloxane containing an alkenyl group with a low degree of polymerization as compared to component (A1). Thus, a bias may occur in a curing reaction in the composition, leading to curing defects and low curability. Note that in particular, a pressure sensitive adhesive layer is generally industrially cured within 1 minute to 10 minutes, and using a long curing process is often difficult in order to uniformly advance a reaction.

However, as described above, the amount of SiH is designed to be in large excess such that the SiH/Vi ratio is 20 or more, and preferably 22 or more, and therefore, even if a portion where the density of alkenyl groups is relatively low exists in the composition, a hydrosilylation reaction is more likely to advance quickly. It is thought that a pressure sensitive adhesive layer where the entire composition is uniformly crosslinked is formed without problems of curing defects and curing delay.

Furthermore, in the present invention, the amount of SiH is designed to be in large excess, and therefore, a large amount of unreacted silicon-bonded hydrogen atoms (SiH) remain in the pressure sensitive adhesive layer after crosslinking. Thus, a bonding force between the pressure sensitive adhesive layer and a base material surface may occur based on an interaction with a hydroxyl group or the like present on the base material surface. As a result, adhesion with regard to a base material is considered to be improved.

For the mass ratio, the component (B) is preferably 1 to 500 parts by mass, and more preferably 30 to 400 parts by mass with regard to a total of 100 parts by mass of the component (A) and component (C) in the composition, for the purpose of technical effects of the present invention, and particularly for use as a pressure sensitive adhesive layer. This is because if the amount of the component (B) is less than the lower limit or exceeds the upper limit, an adhesive force may be insufficient.

Hydrosilylation Reaction Catalyst

The organopolysiloxane composition according to present invention contains a hydrosilylation reaction catalyst. Examples of the hydrosilylation reaction catalyst include platinum-based catalysts, rhodium-based catalysts, and palladium-based catalysts; platinum-based catalysts are preferable because curing of the present composition can be significantly promoted. Examples of the platinum-based catalysts include fine platinum powders, chloroplatinic acids, alcohol solutions of chloroplatinic acids, platinum-alkenylsiloxane complexes, platinum-olefin complexes, and platinum-carbonyl complexes. Platinum-alkenyl siloxane complexes are particularly preferable. Examples of the alkenylsiloxanes include 1,3-divinyl-1,1,3,3-tetramethyl disiloxane, 1,3,5,7-tetramethyl-1,3,5,7-tetravinyl cyclotetrasiloxane, alkenylsiloxanes where a portion of methyl groups in the alkenylsiloxanes is substituted with an ethyl group, phenyl group, a group selected from groups consisting of nitriles, amides, dioxolanes, and sulfolanes, or the like, and alkenylsiloxanes where a vinyl group in the alkenylsiloxanes is substituted with an aryl group, hexenyl group, or the like. A 1,3-divinyl-1,1,3,3,-tetramethyl disiloxane is particularly preferable, because stability of the platinum-alkenylsiloxane complex is favorable. Note that a non-platinum-based metal catalyst such as iron, ruthenium, iron/cobalt, and the like may be used as the catalyst promoting the hydrosilylation reaction.

In the present invention, an amount of the hydrosilylation reaction catalyst is not particularly limited. However, the amount is within a range where an amount of the platinum-based metal is within a range of 0.1 to 200 μm, and may be within a range of 0.1 to 150 ppm, 0.1 to 100 ppm, or 0.1 to 50 ppm, with regard to a total amount of solid content in the composition. Herein, the platinum-based metal is a group VIII metal element including platinum, rhodium, palladium, ruthenium, and iridium, and an amount of a platinum metal excluding a ligand of the hydrosilylation catalyst is preferably within the aforementioned range in practice. Note that “solid content” is a component forming a cured layer (primarily main agents, components providing adhesion, crosslinking agents, catalysts, and other nonvolatile components) when the organopolysiloxane composition according to the present invention is cured, and does not contain a volatile component such as a solvent or the like volatilizing during heat curing.

When the amount of the platinum-based metal in the organopolysiloxane composition according to the present invention is 50 ppm or less (45 ppm or less, 35 ppm or less, 30 ppm or less, 25 ppm or less, or 20 ppm or less), in particular, discoloration or coloring of a transparent pressure sensitive adhesive layer may be suppressed after curing or when exposed to heat or high energy rays such as ultraviolet rays or the like. On the other hand, from the perspective of curability of the organopolysiloxane composition, the amount of the platinum-based metal is 0.1 ppm or more, and when lower than the lower limit, curing defects may occur.

The component (E) is a curing retarder, which is added to suppress a crosslinking reaction between an alkenyl group in the composition and SiH group in the component (C), extend a usable time at ambient temperature, and improve storage stability. Therefore, in practice, the component is almost essential to the organopolysiloxane composition with pressure sensitive adhesive layer forming properties of the present invention.

Specific examples of the component (E) include acetylene compounds, enyne compounds, organic nitrogen compounds, organic phosphorus compounds, and oxime compounds. Even more specific examples include: 3-methyl-1-butyn-3-ol, 3,5-dimethyl-1-hexyn-3-ol, 3-methyl-1-pentyn-3-ol, 1-ethynyl-1-cyclohexanol, phenylbutynol, and other alkyne alcohols; 3-methyl-3-penten-1-yne, 3,5-dimethyl-1-hexyn-3-yne, and other enyne compounds; 1,3,5,7-tetramethyl-1,3,5,7-tetravinyl cyclotetrasiloxane, 1,3,5,7-tetramethyl-1,3,5,7-tetrahexenyl cyclotetrasiloxane, and other methylalkenyl cyclosiloxanes; and benzotriazoles.

From the perspective of curing behavior of the composition, the organopolysiloxane composition with pressure sensitive adhesive layer forming properties of the present invention preferably has an increase in viscosity of 1.5 times or less for 8 hours at room temperature after preparing the composition, and preferably can be cured at 80 to 200° C. “Suppressing an increase in viscosity” is important from the perspective of handling workability, pot life, and properties after curing. This is because curability can be ensured by curing higher than a certain high temperature (80 to 200° C.) even a large excess of component (C) is included and the amount of the platinum-based metal is optionally reduced. Note that the composition can be achieved by selecting a suitable combination of the aforementioned components, hydrosilylation catalyst, and component (E).

The organopolysiloxane composition of the present invention may contain an organic solvent as a solvent in addition to the suitable component (A) and component (B). The type and amount of the organic solvent are adjusted in consideration of coating workability and the like. Examples of the organic solvent include, toluene, xylene, benzene, and other aromatic hydrocarbon solvents, heptane, hexane, octane, isoparaffin, and other aliphatic hydrocarbon solvents, ethyl acetate, isobutyl acetate, and other ester solvents, diisopropyl ether, 1,4-dioxane, and other ether solvents, trichloroethylene, perchloroethylene, methylene chloride, and other chlorinated aliphatic hydrocarbon solvents, solvent volatile oils, and the like. Two or more types may be combined based on the wettability of a sheet-like base material. An amount of the organic solvent added is preferably an amount where a mixture of the component (A) to component (C) can be uniformly coated on a surface of a sheet-like base material, for example, 5 to 3000 parts by mass per a total of 100 parts by mass of the component (A), component (B), and component (C).

The organopolysiloxane composition according to the present invention can optionally contain a component other than the aforementioned components within a scope that does not impair a technical effect of the present invention. Examples can include adhesion promoters; polydimethyl siloxane, polydimethyl diphenyl siloxane, and other nonreactive organopolysiloxanes; phenol-based, quinone-based, amine-based, phosphorus-based, phosphite-based, sulfur-based, and thioether-based antioxidants; triazole, benzophenone, and other light stabilizers; phosphate ester-based, halogen-based, phosphorus-based, antimony-based flame retardants; one or more types of antistatic agents such as cationic surfactants, anionic surfactants, and nonionic surfactants; and the like. Note that a pigment, dye, inorganic fine particles, or the like can be optionally added in addition to these components, but an optional component that impairs optical properties such as transparency or the like and causes coloring of a pressure sensitive adhesive layer is preferably not added.

A method of preparing the organopolysiloxane composition according to the present invention is not particularly limited, and is performed by homogenously mixing the components. A solvent may be added if necessary, and may be prepared by mixing at a temperature of 0 to 200° C. using a conventionally known stirrer or kneader.

The organopolysiloxane composition of the present invention is coated on a base material to form a coating film, and is heated under a temperature condition of 80 to 200° C., and preferably under a temperature condition of 90 to 190° C. to form a cured product. Examples of a coating method include gravure coating, offset coating, offset gravure, roll coating, reverse roll coating, air knife coating, curtain coating, and comma coating.

Range of Pressure Sensitive Adhesion and Adhesive Force

The organopolysiloxane composition of the present invention has a cured layer obtained by curing the composition by a hydrosilylation reaction that is pressure sensitive adhesive. The pressure sensitive adhesive layer of the present invention can be designed to have an adhesive force within a range similar to a silicone pressure sensitive adhesive with an SiH/Vi ratio that is less than 20, and has excellent adhesion of an adhesive layer to a base material. Therefore, in practice, the pressure sensitive adhesive layer of the present invention can be used to replace a conventionally known silicone pressure sensitive adhesive as desired.

Specifically, a polymethyl methacrylate sheet with a thickness of 2 mm provided with a 50 μm thick cured layer obtained by curing the organopolysiloxane composition of the present invention has an adhesive force as measured at a tensile rate of 300 mm/min using a 180° peeling test method in accordance with JIS Z 0237 of 0.02 N/25 mm or more. Note that the aforementioned thickness (50 μm) is a thickness of the cured layer itself, which serves as a reference for objectively defining an adhesive force of the cured layer according to the present invention. The organopolysiloxane composition of the present invention is not limited to a thickness of 50 μm, and it goes without saying that a cured layer or pressure sensitive adhesive layer with an arbitrary thickness can be used.

The 50 μm thick cured layer has an insufficient function as a pressure sensitive adhesive layer when the adhesive force is less than the aforementioned lower limit. Note that a pressure sensitive adhesive layer where the adhesive force is within a range of 0.02 to 35 N/25 mm can generally be designed by using a component described later.

In particular, the 50 μm thick cured layer preferably has an adhesive force under the aforementioned conditions that is 1.0 N/25 mm, and more preferably 2.0 N/25 mm from the perspective of use as a pressure sensitive adhesive layer for a display device.

Properties Related to Transparency, Color Tone, and Coloring/Discoloration of Cured Layer

The organopolysiloxane composition of the present invention is preferably essentially transparent. Specifically, in practice, a film-like cured product with a thickness of 10 to 1000 μm obtained by curing the organopolysiloxane composition of the present invention as a pressure sensitive adhesive layer for a display device must be visually transparent. More objectively, transmittance of light with a wavelength of 450 nm of the pressure sensitive adhesive for a display device containing the cured layer with a thickness of 100 μm may be designed to be 80% or more, and preferably 90% or more and or 95% or more with a value of air set at 100%.

By arbitrarily reducing the amount of the platinum-based metal in the cured layer, the organopolysiloxanes composition of the present invention can be designed such that transparency is not impaired without a color tone thereof greatly changing even when exposed for a long period of time to high temperature and high energy rays such as ultraviolet rays or the like, in addition to the transparency. Specifically, a cured layer with a thickness of 100 μm obtained by curing the organopolysiloxane composition of the present invention can be designed such that immediately after curing, a b* value as measured by a L*a*b* color system as defined in JIS Z 8729 is 0.15 or less, and 0.10 or less. “Having the b* value” means that the cured layer is essentially transparent and is not colored yellow.

The cured layer of the present invention can be designed such that a color tone thereof does not greatly change even if exposed for a long period of time to high temperature or high-energy rays such as ultraviolet rays or the like, and in particular where yellowing problems do not occur. Specifically, even if any of the following evaluations are performed, the cured product with a thickness of 100 μm obtained by curing the organopolysiloxane composition of the present invention can be designed such that a change in the b* value (Δb*) as measured by the L*a*b* color system as defined in JIS Z 8729 before and after evaluations is 0.20 or less, and 0.15 or less. Note that Δb* is an absolute value of a numerical change.

(1) Heat aging evaluation: Cured layer is aged at 105° C. for 300 hours
(2) High energy ray irradiation: Ultraviolet light using a mercury lamp (for example, Optical ModuleX manufactured by Ushio, Inc., or the like) with an intensity of 12 mW/cm² at 365 nm and intensity of 3.5 mW/cm² at 254 nm was irradiated on a sample of the cured layer at room temperature for 75 hours

Use As Pressure Sensitive Adhesive Layer

The cured layer of the present invention can particularly be used as an essentially transparent pressure sensitive adhesive layer. Herein, “essentially transparent” means that when a film-like cured product with a thickness of 10 to 1000 μm is formed, the cured product is visually transparent. In general, transmittance of light at 450 nm of a film-like cured product with a thickness of 100 μm is easily designed to be 80% or more, and preferably 90% or more and 95% or more when a value of air is set at 100%. Furthermore, in order to improve adhesion with an adherend, a surface treatment such as a primer treatment, corona treatment, etching treatment, plasma treatment, or the like may be performed on a surface of a surface of a base material or the pressure sensitive adhesive layer. However, as described above, the pressure sensitive adhesive layer of the present invention has excellent adhesion to a base material such as a display device or the like. Therefore, adhesion to an adherend may be further improved by adding the steps if necessary, or higher productivity may be achieved by omitting the steps.

The curable organopolysiloxane composition according to the present invention can be cured by heating under the aforementioned temperature conditions after coating on a release liner, and then adhered to a film-like base material, tape-like base material, or sheet-like base material (hereinafter, referred to as “film-like base material”) after peeling off the release liner, or can be coated on a film-like base material, and then cured by heating under the aforementioned temperature conditions, to form a pressure sensitive adhesive layer on a surface of the base material. A laminate provided with a cured layer obtained by curing the organopolysiloxane composition according to the present invention on the film-like base material, and in particular, a film-like pressure sensitive adhesive layer, may be used on adhesives tapes, bandages, low temperature supporting bodies, transfer films, labels, emblems, and decorative or explanatory signs. Furthermore, a cured layer obtained by curing the organopolysiloxane composition according to the present invention may be used in assembling automobile parts, toys, electronic circuits, or keyboards. Alternatively, a cured layer, and particularly a film-like pressure sensitive adhesive layer, obtained by curing the organopolysiloxane composition according to the present invention may be used to construct or utilize a laminated touchscreen or flat-panel display.

Examples of types of base materials include paperboard, corrugated cardboard paper, clay coated paper, polyolefin laminated paper, and particularly polyethylene laminated paper, synthetic resin films/sheets, natural fiber materials, synthetic fiber materials, artificial leather materials, and metal foils. Synthetic resin films/sheets are particularly preferable. Examples of synthetic resins include polyimides, polyethylene, polypropylenes, polystyrenes, polyvinyl chlorides, polyvinylidene chlorides, polycarbonates, polyethylene terephthalates, cyclopolyolefins, and nylons. In particular, when heat resistance is required, films of heat resistant synthetic resins such as polyimides, polyether ether ketones, polyethylene naphthalates (PEN), liquid crystal polyarylates, polyamide imides, polyether sulfones, and the like are preferable. On the other hand, for applications requiring visibility such as display devices and the like, transparent base materials, and specifically transparent materials such as polypropylenes, polystyrenes, polyvinylidene chlorides, polycarbonates, polyethylene terephthalates, PENs, and others are preferable.

The base material is preferably film-like or sheet-like. A thickness thereof is not particularly limited, and can be designed to be a desired thickness based on an application. Furthermore, in order to improve adhesion between a supporting film and the pressure sensitive adhesive layer, a supporting film that has been primer treated, corona treated, etching treated, or plasma treated may be used. Furthermore, a material that has been surface treated for scratch prevention, staying prevention, fingerprint adhesion prevention, antiglare, antireflection, antistatic, or the like may be used on an opposite surface from the pressure sensitive adhesive layer surface of the film-like base material.

Gravure coating, offset coating, offset gravure, roller coating using an offset transfer roll coated or the like, reverse roll coating, air knife coating, curtain coating using a curtain flow coater or the like, comma coating, Meyer bar, or other conventionally known method used to form a cured layer can be used as the method of coating to a base material without limitation.

A coating amount can be designed to a desired thickness based on an application of the display device or the like. In particular, when used as a transparent pressure sensitive adhesive layer, a thickness of the pressure sensitive adhesive layer after curing may be 1 to 1000 μm, 5 to 900 μm, or 10 to 800 μm, but is not limited thereto.

When the cured layer obtained by curing organopolysiloxane composition of the present invention is a pressure sensitive adhesive layer, and particularly an essentially transparent pressure sensitive adhesive film, the cured layer is preferably handled as a laminate film adhered in a releasable condition on a film-based material provided with a release layer having a release coding ability. The release layer may be referred to as a release liner, parting layer, or release coating layer. Preferably, a release layer having a release coating ability such as a silicone releasing agent, fluorine releasing agent, alkyd releasing agent, fluorosilicone releasing agent, or the like or a base material itself where fine irregularities are physically formed on a surface of the base material, or that does not easily adhere to the pressure sensitive adhesive layer of the present invention may be used. In particular, the laminate according to the present invention preferably uses a release layer obtained by curing a fluorosilicone releasing agent.

The cure product obtained by curing the organopolysiloxane composition of the present invention is useful as an electronic material, member for displaying device, or member for transducer (including for sensors, speakers, actuators, and generators), and a preferred application of the cured product is a member for displaying device or electronic component. In particular, the cured product in the form of the film, and particularly an essentially transparent pressure sensitive adhesive film is preferably a member for a display or display panel, and is particularly useful in so-called touch panel applications where a device, and particularly an electronic device can be operated by touching a screen with a fingertip or the like.

In particular, the pressure sensitive adhesive layer obtained by curing the organopolysiloxane composition of the present invention can achieve the same pressure sensitive adhesive properties as a conventional silicon pressure sensitive adhesive layer, and can improve adhesion to a base material such as a displaying device or the like without causing curing defects and problems with reduction in curability.

Member for Display or Display Panel

The cure product obtained by curing organopolysiloxane composition of the present invention can be used to construct and utilize a laminated touchscreen or flat-panel display. A specific method of use thereof can be used without particular limitations to a conventionally known use method of a pressure sensitive adhesive layer (and particularly silicone PSA).

For example, the cured product obtained by curing organopolysiloxane composition of the present invention can be used to manufacture a displaying device such as a touch panel or the like as a pressure sensitive adhesive layer or optically transparent silicone pressure sensitive adhesive film as disclosed in the aforementioned Japanese PCT Application 2014-522436 (Patent Document 1), Japanese PCT Application 2013-512326 (Patent Document 2), and the like. Specifically, the cured product obtained by curing the organopolysiloxane composition of the present invention can be used without particular limitation as a cursor sensitive adhesive film or pressure sensitive adhesive layer according to Patent Document 2.

In one example, a touch panel according to the present invention may be a touch panel containing: a base material such as a conductive plastic film or the like where the conductive layer is formed on one surface and a cured layer obtained by curing the curable organopolysiloxane composition of the present invention adhered to a side where the conductive layer is formed or on a surface on an opposite side. The base material is preferably a sheet-like or film-like base material, and examples include resin films and glass sheets. Furthermore, the conductive plastic film may be a resin film or glass sheet, and particularly a polyethylene terephthalate film, where an ITO layer is formed on a surface. These are disclosed in the aforementioned Japanese PCT Application 2013-512326 (Patent Document 2) and the like.

In addition, the cured product obtained by curing the organopolysiloxane composition of the present invention may be used as an adhesive film for a polarizing plate used to manufacture displaying device such as a touch panel or the like, or may be used as a pressure sensitive adhesive layer used to bond together a display module and a touch panel described in JP 2013-065009 A.

### INDUSTRIAL APPLICABILITY

Applications for the curable organopolysiloxane composition of the present invention and cured product obtained by curing the composition are not limited to those disclosed above. A pressure sensitive adhesive film containing the cured product obtained by curing the composition can be used in various displaying devices for displaying a character, symbol, or image, such as a television receiver, a monitor for computer, a monitor for a portable information terminal, a monitoring monitor, a video camera, a digital camera, a mobile phone, a portable information terminal, a display for an instrument panel for an automobile or the like, a display for an instrument panel for various facilities, equipment, and devices, and automatic vending machine, and automatic teller machine, and in-vehicle displaying device, and in-vehicle transmission screen, and the like. A surface shape of the displaying device may be a curved surface shape or a curved shape and not a flat shape. Examples include a curved display or curved transmission screen used in automobiles (including electric automobiles), aircraft, and the like in addition to various flat panel displays (FPD). Furthermore, the displaying devices can display an icon for executing a function or program, a notification display for electronic mail/program or the like, or an operating button of various devices such as a car navigation device, audio device, air conditioner, or the like on a screen or display. A touch panel function may be added where an input operation is enabled by touching the icon, notification display, or operating button using a finger. The device can apply displaying devices such as a CRT display, liquid crystal display, plasma display, organic EL display, inorganic EL display, LED display, surface electrolytic display (SED), field emission display (FED), and the like, and a touch panel utilizing these devices.

The pressure sensitive adhesive layer obtained by curing the organopolysiloxane composition of the present invention is preferably essentially transparent, does not cause curing defects and curability reduction problems, and has excellent adhesion to a base material such as various displaying devices and the like. Therefore, the pressure sensitive adhesive layer can suitably be used in a displaying device for a vehicle with favorable visibility and operability of display contents over a long period of time, and particularly the displaying device for a vehicle optionally having a touch panel function, provided with a curved surface screen or a curved surface display. For example, a displaying device for a vehicle provided with a curved display surface is disclosed in JP 2017-047767 A, JP 2014-182335 A, JP 2014-063064 A, JP 2013-233852 A, and the like. However, the pressure sensitive adhesive layer according to the present invention can be suitably applied to or replace a portion or all of an adhesive layer or pressure sensitive adhesive layer where transparency is required in these documents. Furthermore, it goes without saying that the organopolysiloxane composition with pressure sensitive adhesive layer forming properties of the present invention can be used by replacing an adhesive layer or pressure sensitive adhesive layer where transparency is required that is currently used in other conventionally known curved surface displaying devices. A displaying device design or member thickness is preferably adjusted by a conventionally known technique in order to further advantageously utilize the pressure sensitive adhesive layer of the present invention.

Note that a transparent film-like base material provided with the pressure sensitive adhesive layer of the present invention may be used for scratch prevention, stain prevention, fingerprint adhesion prevention, antistatic prevention, reflection prevention, peeping prevention, and the like of the display surfaces.

### EXAMPLES

Examples and comparative examples will be described below. Note that “cured” in the examples and comparative examples means that compositions were completely cured under various curing conditions.

Preparation of Curable Organopolysiloxane Composition

Curable organopolysiloxane compositions described in the examples and comparative examples were prepared using components shown in Table 1.

Adhesive Force Measurement

The compositions were coated such that a thickness after curing was 50 μm on a PET film (manufactured by Toray Industries, Inc., Product name: Lumirror (registered trademark) #50-T60, Thickness: 50 μm), and then cured at 120° C. The sample was cut into a width of 20 mm, and then a surface of a pressure sensitive adhesive layer was adhered to a PMMA sheet (manufactured by Paltec, Acrylite L001, 50×120×2 mm) or a glass sheet (manufactured by Paltec, float glass, JIS R3202, 75×150×3 mm) using a roller to obtain a test piece. An adhesive force (measurement at width of 20 mm converted to display unit N/25 mm) was measured at a tensile rate of 300 mm/min using a 180° peeling test method in accordance with JIS Z0237 using an Orientec RTC-1210 tensile test after allowing to stand for 30 minutes at room temperature when using the PMMA sheet and performing aging for 80 hours at 100° C. when using the glass sheet. The same adhesive force measuring test was performed three times for the compositions, and an average value thereof was shown.

Materials of the curable organopolysiloxane compositions are shown in Table 1. Note that the viscosity or degree of plasticity of the components were measured at room temperature by the following methods.

Viscosity

The viscosity (mPa·s) is a value measured using a rotational viscometer in accordance with JIS K7117-1, and the kinematic viscosity (mm2/s) is a value measured by an Ubbelohde viscometer in accordance with JIS Z8803.

Degree of Plasticity

The degree of plasticity is indicated by a value (thickness when a load of 1 kgf is applied for 3 minutes on a 4.2 g spherical sample is read up to 1/100 mm, and the numerical value is multiplied by 100 at 25° C.) measured in accordance with a method specified JIS K 6249.

Table 1 Components of Curable Organopolysiloxane Composition

TABLE 1

| Component Name | Component |
|---|---|
| Component A-a | Vinyl functional polydimethyl siloxane, Gum-like |
| | (degree of plasticity 134), Amount of vinyl: 0.018% |
| Component A-b | Vinyl functional polydimethyl siloxane, Gum-like |
| | (degree of plasticity 152), Amount of vinyl: 0.013% |
| Component A-c | Vinyl functional polydimethyl siloxane, |
| | Viscosity: 350 mPa · s, Amount of vinyl: 0.474% |
| Component B | MQ silicone resin containing (CH3)3SiO1/2 unit, |
| | SiO4/2 unit, and hydroxyl group, Amount of OH: |
| | 1.0% Xylene solution (solid content: 62.6%) |
| Component | C Methylhydrogen polysiloxane blocked with |
| | a trimethylsiloxy group at both ends, |
| | Viscosity: 20 mm2/s, Amount of SiH: 1.59% |
| Component D-a | Platinum hydrosilylation reaction catalyst, |
| | Containing 0.64% of platinum |
| Component | D-b Platinum hydrosilylation reaction catalyst, |
| | Containing 0.73% of platinum |
| Component E-a | 3,5-dimethyl-1-hexyn-3-ol |
| Component E-b | 2-ethynyl-4-methyl-2-pentene |

Note:
Each % in Table 1 indicates wt. %.

### Example 1

20.5 parts by weight of the vinyl-functional polydimethyl siloxane of component A-b, 0.004 parts by weight of the vinyl-functional polydimethyl siloxane of component A-c, 60.3 parts by weight of the MQ silicone resin of component B, 0.20 parts by weight of the methylhydrogen polysiloxane blocked with a trimethylsiloxy group at both ends of component C, 0.050 parts by weight of the curing retarder of component E-a, and 19.2 parts by weight of toluene were mixed well at room temperature, and then 0.10 parts by weight of the platinum hydrosilylation reaction catalyst of component D-b was added to the mixture to obtain a curable organopolysiloxane composition. The molar ratio (SiH/V ratio) in the component (C) with regard to the number of alkenyl groups in the component (A) was 29, and the amount of platinum metals with regard to the solid content was 10 ppm.

The composition was cured for 3 minutes at a curing temperature of 120° C. The adhesive force with regard to a PMMA sheet was measured by the method described above (adhesive force measurement), and evaluation results and the like thereof were shown in Table 2.

### Example 2

25.6 parts by weight of the vinyl-functional polydimethyl siloxane of component A-a, 0.04 parts by weight of the vinyl-functional polydimethyl siloxane of component A-c, 56.4 parts by weight of the MQ silicone resin of component B, 0.34 parts by weight of the methylhydrogen polysiloxane blocked with a trimethylsiloxy group at both ends of component C, 0.21 parts by weight of the curing retarder of component E-b, and 17.6 parts by weight of toluene were mixed well at room temperature, and then 0.90 parts by weight of the platinum hydrosilylation reaction catalyst of component D-b was added to the mixture to obtain a curable organopolysiloxane composition. The SiH/Vi ratio was 30, and the amount of platinum metals with regard to the solid content was 100 ppm.

The composition was cured for 2 minutes at a curing temperature of 120° C. Aging was performed for 80 hours at 100° C., and then the adhesive force with regard to a glass sheet was measured by the method described above (adhesive force measurement). Evaluation results and the like thereof were shown in Table 3.

### Example 3

25.6 parts by weight of the vinyl-functional polydimethyl siloxane of component A-a, 0.74 parts by weight of the vinyl-functional polydimethyl siloxane of component A-c, 56.4 parts by weight of the MQ silicone resin of component B, 0.57 parts by weight of the methylhydrogen polysiloxane blocked with a trimethylsiloxy group at both ends of component C, 0.21 parts by weight of the curing retarder of component E-b, and 17.6 parts by weight of toluene were mixed well at room temperature, and then 0.90 parts by weight of the platinum hydrosilylation reaction catalyst of component D-a was added to the mixture to obtain a curable organopolysiloxane composition. The SiH/Vi ratio was 30, and the amount of platinum metals with regard to the solid content was 100 ppm.

The composition was cured for 2 minutes at a curing temperature of 120° C. Aging was performed for 80 hours at 100° C., and then the adhesive force with regard to a glass sheet was measured by the method described above (adhesive force measurement). Evaluation results and the like thereof were shown in Table 3.

### Example 4

21.6 parts by weight of the vinyl-functional polydimethyl siloxane of component A-a, 0.04 parts by weight of the vinyl-functional polydimethyl siloxane of component A-c, 63.2 parts by weight of the MQ silicone resin of component B, 0.20 parts by weight of the methylhydrogen polysiloxane blocked with a trimethylsiloxy group at both ends of component C, 0.20 parts by weight of the curing retarder of component E-b, and 14.9 parts by weight of toluene were mixed well at room temperature, and then 0.90 parts by weight of the platinum hydrosilylation reaction catalyst of component D-b was added to the mixture to obtain a curable organopolysiloxane composition. The SiH/Vi ratio was 21.7, and the amount of platinum metals with regard to the solid content was 100 ppm.

The composition was cured for 3 minutes at a curing temperature of 120° C. The adhesive force with regard to a PMMA sheet was measured by the method described above (adhesive force measurement), and evaluation results and the like thereof were shown in Table 2.

### Example 5

20.5 parts by weight of the vinyl-functional polydimethyl siloxane of component A-b, 0.16 parts by weight of the vinyl-functional polydimethyl siloxane of component A-c, 60.3 parts by weight of the MQ silicone resin of component B, 0.20 parts by weight of the methylhydrogen polysiloxane blocked with a trimethylsiloxy group at both ends of component C, 0.050 parts by weight of the curing retarder of component E-a, and 19.2 parts by weight of toluene were mixed well at room temperature, and then 0.20 parts by weight of the platinum hydrosilylation reaction catalyst of component D-a was added to the mixture to obtain a curable organopolysiloxane composition. The SiH/Vi ratio was 24.3, and the amount of platinum metals with regard to the solid content was 22 ppm.

The composition was cured for 3 minutes at a curing temperature of 120° C. The adhesive force with regard to a PMMA sheet was measured by the method described above (adhesive force measurement), and evaluation results and the like thereof were shown in Table 2.

### Example 6

20.5 parts by weight of the vinyl-functional polydimethyl siloxane of component A-b, 0.01 parts by weight of the vinyl-functional polydimethyl siloxane of component A-c, 60.3 parts by weight of the MQ silicone resin of component B, 0.20 parts by weight of the methylhydrogen polysiloxane blocked with a trimethylsiloxy group at both ends of component C, 0.050 parts by weight of the curing retarder of component E-a, and 19.2 parts by weight of toluene were mixed well at room temperature, and then 0.20 parts by weight of the platinum hydrosilylation reaction catalyst of component D-b was added to the mixture to obtain a curable organopolysiloxane composition. The SiH/Vi ratio was 30.9, and the amount of platinum metals with regard to the solid content was 22 ppm.

The composition was cured for 3 minutes at a curing temperature of 120° C. The adhesive force with regard to a PMMA sheet was measured by the method described above (adhesive force measurement), and evaluation results and the like thereof were shown in Table 2.

### Reference Example

21.6 parts by weight of the vinyl-functional polydimethyl siloxane of component A-a, 0.74 parts by weight of the vinyl-functional polydimethyl siloxane of component A-c, 63.2 parts by weight of the MQ silicone resin of component B, 0.20 parts by weight of the methylhydrogen polysiloxane blocked with a trimethylsiloxy group at both ends of component C, 0.20 parts by weight of the curing retarder of component E-b, and 14.9 parts by weight of toluene were mixed well at room temperature, and then 0.90 parts by weight of the platinum hydrosilylation reaction catalyst of component D-a was added to the mixture to obtain a curable organopolysiloxane composition. The SiH/Vi ratio was 11.7, and the amount of platinum metals with regard to the solid content was 100 ppm.

The composition was cured for 3 minutes at a curing temperature of 120° C. As a result of measuring the adhesive force with regard to a PMMA sheet by the method described above (adhesive force measurement), the adhesive force was 20.5 N/25 mm.

### Comparative Example 1

20.5 parts by weight of the vinyl-functional polydimethyl siloxane of component A-b, 1.064 parts by weight of the vinyl-functional polydimethyl siloxane of component A-c, 60.3 parts by weight of the MQ silicone resin of component B, 0.20 parts by weight of the methylhydrogen polysiloxane blocked with a trimethylsiloxy group at both ends of component C, 0.050 parts by weight of the curing retarder of component E-a, and 19.2 parts by weight of toluene were mixed well at room temperature, and then 0.10 parts by weight of the platinum hydrosilylation reaction catalyst of component D-b was added to the mixture to obtain a curable organopolysiloxane composition. The SiH/Vi ratio was 10, and the amount of platinum metals with regard to the solid content was 10 ppm.

The composition was cured for 3 minutes at a curing temperature of 120° C. The adhesive force with regard to a PMMA sheet was measured by the method described above (adhesive force measurement), and evaluation results and the like thereof were shown in Table 2.

### Comparative Example 2

25.6 parts by weight of the vinyl-functional polydimethyl siloxane of component A-a, 0.74 parts by weight of the vinyl-functional polydimethyl siloxane of component A-c, 56.4 parts by weight of the MQ silicone resin of component B, 0.21 parts by weight of the methylhydrogen polysiloxane blocked with a trimethylsiloxy group at both ends of component C, 0.21 parts by weight of the curing retarder of component E-b, and 17.6 parts by weight of toluene were mixed well at room temperature, and then 0.90 parts by weight of the platinum hydrosilylation reaction catalyst of component D-a was added to the mixture to obtain a curable organopolysiloxane composition. The SiH/Vi ratio was 10.7, and the amount of platinum metals with regard to the solid content was 100 ppm.

The composition was cured for 2 minutes at a curing temperature of 120° C. Aging was performed for 80 hours at 100° C., and then the adhesive force with regard to a glass sheet was measured by the method described above (adhesive force measurement). Evaluation results and the like thereof were shown in Table 3.

### Comparative Example 3

25.6 parts by weight of the vinyl-functional polydimethyl siloxane of component A-a, 0.04 parts by weight of the vinyl-functional polydimethyl siloxane of component A-c, 56.4 parts by weight of the MQ silicone resin of component B, 0.21 parts by weight of the methylhydrogen polysiloxane blocked with a trimethylsiloxy group at both ends of component C, 0.21 parts by weight of the curing retarder of component E-b, and 17.6 parts by weight of toluene were mixed well at room temperature, and then 0.90 parts by weight of the platinum hydrosilylation reaction catalyst of component D-a was added to the mixture to obtain a curable organopolysiloxane composition. The SiH/Vi ratio was 18.4, and the amount of platinum metals with regard to the solid content was 100 ppm.

The composition was cured for 2 minutes at a curing temperature of 120° C. Aging was performed for 80 hours at 100° C., and then the adhesive force with regard to a glass sheet was measured by the method described above (adhesive force measurement). Evaluation results and the like thereof were shown in Table 3.

Table 2 Adhesive force of cured layer with 50 μm film thickness with regard to PMMA sheet

Table 2

| | Example | Example | Example | Example | Comparative |
|---|---|---|---|---|---|
| Composition | 1 | 4 | 5 | 6 | Example 1 |
| SiH/Vi ratio | 29 | 21.7 | 24.3 | 30.9 | 10 |
| Adhesive force | 20.5 | 20.7 | 21.7 | 22.0 | 16.9 |
| (N/25 mm) | | | | | |

Table 3 Adhesive force of cured layer with 50 μm film thickness with regard to glass sheet (after aging at 100° C.)

TABLE 3

| Physical | | | Comparative | Comparative |
|---|---|---|---|---|
| Properties | Example | Example | Example | Example |
| Composition | 2 | 3 | 2 | 3 |
| | Aging at 100° C. for 30 hours | | | |
| SiH/Vi ratio | 30 | 30 | 10.7 | 18.4 |
| Adhesive force | 26.7 | 26.1 | 25.6 | 26.0 |
| (N/25 mm) | | | | |
| | Aging at 100° C. for 80 hours | | | |
| SiH/Vi ratio | 30 | 30 | 10.7 | 18.4 |
| Adhesive force | 37.2 | 38.1 | 27.5 | 27.2 |
| (N/25 mm) | | | | |

The compositions according to the examples and cured layers thereof have excellent curability, particularly when an amount of a curing catalyst is low (platinum amount: 10 ppm or 22 ppm), as shown in Table 2. Furthermore, as shown in Table 3, the compositions according to the examples have excellent adhesion to a polar surface such as glass or the like. Furthermore, as shown by the adhesive force of the compositions according to the examples in Table 2 and the like and the adhesive force of the reference examples, the adhesive force can be designed within a scope equivalent to a silicone pressure sensitive adhesive with an SiH/Vi ratio that is less than 20 for the compositions according to the present invention, and in practice, a sufficient adhesive force can be achieved.

1. An organopolysiloxane composition with pressure sensitive adhesive layer forming properties, the organopolysiloxane composition comprising:
(A) an organopolysiloxane having an average of more than one alkenyl group in a molecule;
(B) an organopolysiloxane resin;
(C) an organohydrogen polysiloxane having at least two Si—H bonds in a molecule; and
(D) a hydrosilylation reaction catalyst;
wherein component (C) is present in an amount where a molar ratio of an amount of an SiH group in component (C) with regard to a sum of an amount of alkenyl groups in component (A) and an amount of alkenyl groups in component (B) is 20 to 60.

2. The organopolysiloxane composition according to claim 1, wherein component (C) is present in an amount such that the molar is 22 to 50.

3. The organopolysiloxane composition according to claim 1, wherein:
at least a portion of component (A) is (A1) a raw rubber-like organopolysiloxane containing an alkenyl group, having a viscosity of 100,000 mPa·s or more at 25° C., or a degree of plasticity as measured in accordance with a method stipulated in JIS K6249 within a range of 50 to 200;
at least a portion of the component (B) is (B1) a resin that contains an R₃SiO_{1/2} unit (M unit) and an SiO_{4/2} unit (Q unit), and optionally a hydroxyl group or hydrolyzable group, where R represents a monovalent organic group and 90 mol % or more of R is a phenyl group or an alkyl group with 1 to 6 carbon atoms; and
an amount of a vinyl moiety in an alkenyl group in component (A1) is within a range of 0.005 to 0.400 wt. %, and component (B) is within a range of 1 to 500 parts by mass with regard to 100 parts by mass of a sum of components (A) and (C) in the composition.

4. The organopolysiloxane composition according to claim 3, wherein component (A) is a mixture of component (A1) and (A2) an organopolysiloxane containing an alkenyl group with a viscosity at 25° C. that is less than 100,000 mPa·s, and a mass ratio of both that is within a range of 50:50 to 100:0.

5. The organopolysiloxane composition according to claim 1, further comprising (E) at least one curing retarder.

6. The organopolysiloxane according to claim 1, wherein a viscosity of the composition after 8 hours at room temperature from preparing the composition is within 1.5 times a viscosity of the composition immediately after preparing the composition, and curing is possible at 80 to 200° C.

7. The organopolysiloxane composition according to claim 1, wherein an amount of a platinum-based metal in solid content is within a range of 0.1 to 200 ppm.

8. The organopolysiloxane composition according to claim 1, wherein a cured layer having a thickness of 100 μm obtained by curing the composition is essentially transparent, and a polymethyl methacrylate sheet with a thickness of 2 mm provided with a 50 μm thick cured layer obtained by curing the composition has an adhesive force as measured at a tensile rate of 300 mm/min using a 180° peeling test method in accordance with JIS Z 0237 of 0.02 N/25 mm or more.

9. A pressure sensitive adhesive composition, comprising the organopolysiloxane composition according to claim 1.

10. A pressure sensitive adhesive layer obtained by curing the organopolysiloxane composition according to claim 1.

11. The pressure sensitive adhesive layer according to claim 10, which is film-like and essentially transparent.

12. A laminate, comprising a pressure sensitive adhesive layer obtained by curing the organopolysiloxane composition according to claim 1 on a film-like base material.

13. The laminate according to claim 12, wherein a release layer for the pressure sensitive adhesive layer is provided on one or more film-like base materials.

14. A laminate comprising:
a film-like base material;
a first release layer formed on the film-like base material;
a pressure sensitive adhesive layer formed by coating and curing the organopolysiloxane composition according to claim 1 on the release layer; and
a second release layer laminated on the pressure sensitive adhesive layer.

15. A member for a display device or an electronic material, obtained by curing the organopolysiloxane composition according to claim 1.

16. An electronic component or display device, comprising the member according to claim 15.

17. A display panel or a display, comprising the pressure sensitive adhesive layer according to claim 11.

18. A touch panel, comprising a pressure sensitive adhesive layer obtained by curing the organopolysiloxane composition according to claim 1 adhered to a base material where a conductive layer is formed on one surface and to the conductive layer of the base material or on a surface opposite thereof.

19. The touch panel according to claim 18, wherein the base material where the conductive layer is formed is a resin film or glass sheet where an ITO layer is formed on one surface.
